(19) United States
(12) Patent Application Publication
(10) Pub. No.: US 2002/0137654 A1
(43) Pub. Date: Sep. 26, 2002

(54) Enzymatic detergent compositions

(75) Inventors: Ronald Hage, Vlaardingen (NL); Jan Klugkist, Vlaardingen (NL); Ton Swarthoff, Vlaardingen (NL); Patrick Van Der Waal, Vlaardingen (NL)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/013,755

(22) Filed: Dec. 11, 2001

(30) Foreign Application Priority Data
Dec. 14, 2000 (EP) 00204514.4

(51) Int. Cl. C11D 3/00; C11D 3/386

(52) U.S. Cl. 510/392; 510/530

(57) ABSTRACT

There is provided an enzymatic detergent composition which comprises: (a) surfactant; and (b) 10-20,000 LU per gram of the detergent composition of a lipolytic enzyme obtainable from Humicola lanuginosa, Pseudomonas pseudoalcaligenes, Rhizomucor miehei and (c) a non-cross-bridged polydentate N-donor ligand capable of forming a complex with a transition metal, wherein said complex is capable of catalysing the bleaching of stains on fabrics by means of atmospheric oxygen.

### TECHNICAL FIELD

The present invention generally relates to the field of enzymatic detergent and cleaning compositions. More in particular, the invention is concerned with enzymatic detergent compositions comprising enzymes having lipolytic activity.

### BACKGROUND AND PRIOR ART

Various types of enzymes are known as additives for detergent compositions. For example, detergent compositions containing proteases, cellulases, amylases, lipases and various combinations thereof have been described in the literature and several such products have appeared on the market. The present invention is concerned with detergent compositions comprising lipolytic enzymes or lipases. Such enzymes could contribute to the removal of fatty soil from fabrics by hydrolysing one or more of the ester bonds in tri-glycerides.

EP-A-214 761 (Novo Nordisk) discloses lipases which are derived from organisms of the species Pseudomonas cepacia, and EP-A-258 068 (Novo Nordisk) discloses lipases which are derived from organisms of the genus Humicola. Both patent applications also describe the use of these lipases as detergent additives.

Further examples of lipase-containing detergent compositions are provided by EP-A-205 208 and EP-A-206 390 (both Unilever), which disclose a class of lipases defined on the basis of their immunological relationships, and describe their use in detergent compositions and textile washing. The preferred lipases are those from Pseudomonas fluorescens, Pseudomonas gladioli and Chromobacter species.

EP-A-331 376 (Amano) describes lipases, their use and their production by means of recombinant DNA (rDNA) techniques, and includes an amino acid sequence of lipase from Pseudomonas cepacia. Further examples of lipase enzymes produced by means of rDNA techniques are given in WO-A-89/09263 and EP-A-218 272 (both Gist-Brocades).

In spite of the large number of publications on lipase enzymes and their modifications, only the lipase derived from Humicola lanuginosa and produced in Aspergillus oryzae as host has so far found wide-spread application as additive for fabric washing products. It is available from Novo-Nordisk under the trade name Lipolase (TM).

In his article in Chemistry and Industry 1990, pages 183-186, Henrik Malmos notes that it is known that generally the activity of lipases during the washing process is low, and Lipolase (TM) is no exception. During the drying process, when the water content of the fabric is reduced, the enzyme regains its activity and the fatty stains are hydrolysed. During the following wash cycle the hydrolysed material is removed. This also explains why the effect of lipases is low after the first washing cycle, but significant in the following cycles. These findings are also described by Aaslyng et al. (1991), in “Mechanistic Studies of Proteases and Lipases for the Detergent Industry”, J.Chem.Tech. Biotechnol. 50, 321-330.

The inventors of the present application regard it as a disadvantage of the existing lipase containing detergent products that no significant cleaning benefit can be expected from the presenence of the lipolytic enzyme when the products are used to wash fabrics which have not been in contact with the detergent product before.

It is therefore an object of the present invention to provide an enzymatic detergent composition which exhibits a superior cleaning activity on oily stains, and which consequently will exhibit lipolytic activity when used to wash fabrics which have not been in contact with the detergent product before. It is also an object of the present invention to provide an enzymatic detergent composition which is especially suitable for use in combination with a tumble dryer.

We have now surprisingly found that certain lipolytic enzymes or lipases can synergistically interact with certain transition metal bleach catalysts to provide superior cleaning performance to detergent compositions containing them.

### DEFINITION OF THE INVENTION

According to a first aspect of the invention, there is provided an enzymatic detergent composition comprising:

(a) a surfactant;

(b) 10-20,000 LU per gram of the detergent composition of a lipolytic enzyme obtainable from Humicola lanuginosa, Pseudomonas pseudoalcaligenes, Rhizomucor miehei and

(c) a non-cross-bridged polydentate N-donor ligand capable of forming a complex with a transition metal, wherein said complex is capable of catalysing the bleaching of stains on fabrics by means of atmospheric oxygen.

According to a second aspect of the invention, there is provided a process for cleaning fabrics using the composition of the invention.

### DESCRIPTION OF THE INVENTION

(a) The Surfactant

A first element of the enzymatic detergent compositions of the present invention is the surfactant. The compositions of the invention will contain one or more detergent-active compounds (surfactants) which may be chosen from soap and non-soap anionic, cationic, nonionic, amphoteric and zwitterionic detergent-active compounds, and mixtures thereof. Many suitable detergent-active compounds are available and are fully described in the literature, for example, in “Surface-Active Agents and Detergents”, Volumes I and II, by Schwartz, Perry and Berch.

The preferred detergent-active compounds that can be used are soaps and synthetic non-soap anionic and nonionic compounds. Anionic surfactants are well-known to those skilled in the art. Examples include alkylbenzene sulphonates, particularly linear alkylbenzene sulphonates having an alkyl chain length of C₈-C₁₅; primary and secondary alkylsulphates, particularly C₈-C₁₅ primary alkyl sulphates; alkyl ether sulphates; olefin sulphonates; alkyl xylene sulphonates; dialkyl sulpho-succinates; and fatty acid ester sulphonates. Sodium salts are generally preferred.

Nonionic surfactants that may be used include the primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 (and preferably 3 to 7) moles of ethylene oxide per mole of alcohol. Non-ethoxylated nonionic surfactants include alkylpolyglycosides, glycerol monoethers, and polyhydroxy-amides (glucamide). If the detergent composition comprises both nonionic and anionic surfactants, it is preferred that the ratio of nonionic surfactant to anionic surfactant is at least 1 to 3, more preferably at least 1 to 1.

The choice of detergent-active compound (surfactant), and the amount present, will depend on the intended use of the detergent composition. In fabric washing compositions, different surfactant systems may be chosen, as is well known to the skilled formulator, for handwashing products and for products intended for use in different types of washing machine.

The total amount of surfactant present will also depend on the intended end use and may be as high as 60% by weight, for example, in a composition for washing fabrics by hand. In compositions for machine washing of fabrics, an amount of from 5 to 40% by weight is generally appropriate. Detergent compositions suitable for use in most automatic fabric washing machines generally contain anionic non-soap surfactant, or nonionic surfactant, or combinations of the two in any ratio, optionally together with soap.

Also applicable are surfactants such as those described in EP-A-328 177 (Unilever), which show resistance to salting-out, the alkyl polyglycoside surfactants described in EP-A-070 074, and alkyl monoglycosides.

Preferred surfactant systems are mixtures of anionic with nonionic detergent active materials, in particular the groups and examples of anionic and nonionic surfactants pointed out in EP-A-346 995 (Unilever). Especially preferred is surfactant system which is a mixture of an alkali metal salt of a C₁₆-C₁₈ primary alcohol sulphate together with a C₁₂-C₁₅ primary alcohol 3-7 EO ethoxylate.

The nonionic detergent is preferably present in amounts greater than 10%, e.g. 25-90% by weight of the surfactant system. Anionic surfactants can be present for example in amounts in the range from about 5% to about 40% by weight of the surfactant system.

(b) The Lipolytic Enzyme

As a second constituent, the enzymatic detergent compositions of the invention comprise 10-20,000 LU per gram of the detergent composition of a lipolytic enzyme selected from the group consisting of Lipolase, Lipolase ultra, LipoPrime, Lipomax, Liposam, and lipase from Rhizomucor miehei (e.g. as described in EP-A-238 023 (Novo Nordisk).

The enzymatic detergent compositions of the invention further comprise 10-20,000 LU per gram, and preferably 50-2,000 LU per gram of the detergent composition, of an lipolytic enzyme. In this specification LU or lipase units are defined as they are in EP-A-258 068 (Novo Nordisk).

A further method of assessing the enzymatic activity is by measuring the reflectance at 460 nm according to standard techniques.

Suitable enzymes for the compositions of the invention can be found in the enzyme classes of the esterases and lipases, (EC 3.1.1.*, wherein the asterisk denotes any number).

A characteristic feature of lipases is that they exhibit interfacial activation. This means that the enzyme activity is much higher on a substrate which has formed interfaces or micelles, than on fully dissolved substrate. Interface activation is reflected in a sudden increase in lipolytic activity when the substrate concentration is raised above the critical micel concentration (CMC) of the substrate, and interfaces are formed. Experimentally this phenomenon can be observed as a discontinuity in the graph of enzyme activity versus substrate concentration. Contrary to lipases, however, cutinases do not exhibit any substantial interfacial activation.

Because of this characteristic feature, i.e. the absence of interfacial activation, we define for the purpose of this patent application Cutinases as lipolytic enzymes which exhibit substantially no interfacial activation. Cutinases therefor differ from classical lipases in that they do not possess a helical lid covering the catalytic binding site. Cutinases belong to a different subclass of enzymes (EC 3.1.1.50) and are regarded to be outside the scope of the present invention.

Of main interest for the present invention are fungal lipases, such as those from Humicola lanuginosa and Rhizomucor miehei. Particularly suitable for the present invention is the lipase from Humicola lanuginosa strain DSM 4109, which is described in EP-A-305 216 (Novo Nordisk), and which is commercially available as Lipolase (TM). Also suitable ar variants of this enzyme, such as described in WO-A-92/05249, WO-A-94/25577, WO-A-95/22615, WO-A-97/04079, WO-A-97/07202, WO-A-99/42566, WO-A-00/60063. Especially preferred is the variant D96L which is commercially available from Novozymes as Lipolase ultra, and the variant which is sold by Novozymes under the trade name LipoPrime. The lipolytic enzyme of the present invention can usefully be added to the detergent composition in any suitable form, i.e. the form of a granular composition, a slurry of the enzyme, or with carrier material (e.g. as in EP-A-258 068 and the Savinase (TM) and Lipolase (TM) products of Novozymes). A good way of adding the enzyme to a liquid detergent product is in the form of a slurry containing 0.5 to 50% by weight of the enzyme in a ethoxylated alcohol nonionic surfactant, such as described in EP-A-450 702 (Unilever).

The enzyme to be used in the detergent compositions according to the invention can be produced by cloning the gene for the enzyme into a suitable production organism, such as Bacilli, or Pseudomonaceae, yeasts, such as Saccharomyces, Kluyveromyces, Hansenula or Pichia, or fungi like Aspergillus. The preferred production organism is Aspergillus with especial preference for Aspergillus oryzae.

(c) The Bleach Catalyst.

As a third component, the enzymatic detergent compositons of the invention comprise a bleach catalyst, which is a complex of a transition metal and a polydentate nitrogen donor ligand excluding cross-bridged macrocyclic ligands.

The bleach catalyst per se may be selected from a wide range of organic molecules (ligands) and complexes thereof. Suitable organic molecules (ligands) and complexes for use with an oxygen solution boosting agent are found, for example in: GB 9906474.3; GB 9907714.1; GB 98309168.7, GB 98309169.5; GB 9027415.0 and GB 9907713.3; DE-A-19755493; EP-A-999050; WO-A-9534628; EP-A-458379; EP-A-909809; U.S. Pat. No. 4,728,455; WO-A-98/39098; WO-A-98/39406, WO-A-9748787, WO-A-00/29537 and WO-A-00/52124, the complexes and organic molecule (ligand) precursors of which are herein incorporated by reference. The preferred catalysts are transition metal complexes of MeN4Py (N,N-bis(pyridin-2-yl-methyl)-1,1-bis(pyridin-2-yl)-1-aminoethane) ligand, N,N-bis(pyridin-2-yl-methyl)-1,1-bis(pyridin-2-yl)-aminomethane, 1,4-bis(quinolin-2-ylmethyl)-7-ethyl-1,4,7-triazacyclononane; 1H-1,4,8,11-Benzotetraazacyclotridecine-2,5,7,10(6H,11H) tetrone, 13,14-dichloro-6,6-diethyl-3,4,8,9-tetrahydro-3,3,9,9-tetramethyl; N-methyl-N,N′,N′-tris(3-methyl-pyridin-2-ylmethyl)ethylene-1,2-diamine; N-benzyl-N,N′,N′-tris(3-methyl-pyridin-2-ylmethyl)ethylene-1,2-diamine; N-methyl-N,N′,N′-tris(pyridin-2-ylmethyl)ethylene-1,2-diamine; N-benzyl-N,N′,N′-tris(pyridin-2-ylmethyl)ethylene-1,2-diamine; N,N,N′,N′-tetrakis(3-methyl-pyridin-2-ylmethyl)ethylene-1,2-diamine; N,N,N′,N′-tetrakis(pyridin-2-ylmethyl)ethylene-1,2-diamine; N,N′,N′-tris(3-methyl-pyridin-2-ylmethyl)-ethylenediamine; N-trimethylammoniumpropyl-N,N′,N′-tris(pyridin-2-ylmethyl)-ethylenediamine; N-(2-hydroxyethylene)-N,N′,N′-tris(pyridin-2-ylmethyl)-ethylenediamine; N,N′-dimethyl-N,N′-bis(pyridin-2-ylmethyl)-cyclohexane-1,2-diamine; N-(2-hydroxyethylene)-N,N′,N′-tris(3-methyl-pyridin-2-ylmethyl)-ethylenediamine; N-methyl-N,N′,N′-tris(pyridin-2-ylmethyl)-ethylenediamine; N-methyl-N,N′,N′-tris(5-ethyl-pyridin-2-ylmethyl)-ethylenediamine; N-methyl-N,N′,N′-tris(5-methyl-pyridin-2-ylmethyl)-ethylenediamine; N-ethyl-N,N′,N′-tris(3-methyl-pyridin-2-ylmethyl)-ethylenediamine; N,N,N′-tris(3-methyl-pyridin-2-ylmethyl)-N′(2′-methoxy-ethyl-l)-ethylenediamine; N,N,N′-tris(1-methyl-benzimidazol-2-yl)-N′-methyl-ethylenediamine; N-(furan-2-yl)-N,N′,N′-tris(3-methyl-pyridin-2-ylmethyl)-ethylenediamine; N-(2-hydroxyethylene)-N,N′,N′-tris(3-ethyl-pyridin-2-ylmethyl)-ethylenediamine; N-(2-hydroxyethyl)-N,N′,N′-tris(3-methyl-pyridin-2-ylmethyl)ethylene-1,2-diamine; N-(2-methoxyethyl)-N,N′,N′-tris(3-methyl-pyridin-2-ylmethyl)ethylene-1,2-diamine; N-methyl-N,N′,N′-tris(5-methyl-pyridin-2-ylmethyl)ethylene-1,2-diamine; N-ethyl-N,N′,N′-tris(5-methyl-pyridin-2-ylmethyl)ethylene-1,2-diamine; N-benzyl-N,N′,N′-tris(5-methyl-pyridin-2-ylmethyl)ethylene-1,2-diamine; N-(2-hydroxyethyl)-N,N′,N′-tris(5-methyl-pyridin-2-ylmethyl)ethylene-1,2-diamine; N-(2-methoxyethyl)-N,N′,N′-tris(5-methyl-pyridin-2-ylmethyl)ethylene-1,2-diamine; N-methyl-N,N′,N′-tris(3-ethyl-pyridin-2-ylmethyl)ethylene-1,2-diamine; N-ethyl-N,N′,N′-tris(3-ethyl-pyridin-2-ylmethyl)ethylene-1,2-diamine; N-benzyl-N,N′,N′-tris(3-ethyl-pyridin-2-ylmethyl)ethylene-1,2-diamine; N-(2-hydroxyethyl)-N,N′,N′-tris(3-ethyl-pyridin-2-ylmethyl)ethylene-1,2-diamine; N-(2-methoxyethyl)-N,N′,N′-tris(3-ethyl-pyridin-2-ylmethyl)ethylene-1,2-diamine; N-methyl-N,N′,N′-tris(5-ethyl-pyridin-2-ylmethyl)ethylene-1,2-diamine; N-ethyl-N,N′,N′-tris(5-ethyl-pyridin-2-ylmethyl)ethylene-1,2-diamine; N-benzyl-N,N′,N′-tris(5-ethyl-pyridin-2-ylmethyl)ethylene-1,2-diamine; and N-(2-methoxyethyl)-N,N′,N′-tris(5-ethyl-pyridin-2-ylmethyl)ethylene-1,2-diamine.

Below is found a non-exhaustive list of ligands from with air bleaching catalysts (transition-metal complexes) may be formed. It will be evident to one skilled in the art that various variations or substitution of these compounds may be made without substantially changing their activity. The air bleaching catalysts may be preformed or formed in situ during an aqueous wash when the ligand readily forms a complex with available trace transition metal ions in aqueous solution. Preferred transition metals are iron and manganese and in particular iron. Nevertheless, it is a mater of routine experimentation or referring to the literature to determine which transition metal provides greatest utility or suitable preparation thereof. In the case of a preformed complex the selection of the counter ion Y for establishing charge neutrality is not critical for the activity of the complex. Non-limiting examples of said counter ions are chloride, sulphate, nitrate, methylsulphate, surfactant-ions, such as long chain alkylsulphates, alkylsulphonates, alkylbenzenesulphonates, tosylate, trifluoromethylsulphonate, perchlorate, BPh4-, PF6-, and mixtures thereof.

The non-exhaustive list is: tris(pyridin-2-ylmethyl)amine; 1,4,7-tris(pyrazol-1-ylmethyl)-1,4,7-triazacyclononane; 1,4-bis(quinolin-2-ylmethyl)-7-ethyl-1,4,7-triazacyclononane; 1,1-bis(pyridin-2-yl)-N-methyl-N-(pyridin-2-ylmethyl)methylamine; 1,1-bis(pyridin-2-yl)-N,N-bis(6-methyl-pyridin-2-ylmethyl)methylamine; 2,6-bis(pyridin-2-ylmethyl)-1,1,7,7-tetrakis(pyridin-2-yl) -2,6-diazaheptane; 1,1-bis(pyridin-2-yl)-1-benzyl-N,N-bis(pyridin -2-ylmethyl)methylamine; 1,1-bis(pyridin-2-yl) -N,N-bis(5-methoxycarbonyl-pyridin-2-ylmethyl)methylamine; 1-(α,α-bis(pyridin-2-yl))methyl-4,7-dimethyl-1,4,7-triazacyclononane; 1-(α,α-bis(pyridin-2-yl))ethyl-4,7-dimethyl-1,4,7-triazacyclononane; 2,2,4,4-tetrakis(pyridin-2-yl)-3-azapentane; 1,1-bis(pyridin-2yl)-N,N-bis(benzimidazol -2-yl-methyl)methylamine; 2,6-bis(methoxy-bis(pyridin-2-yl)methyl)pyridin; 2,6-bis(hydroxy-bis-pyridin-2-yl)-methyl)pyridin;(N-methyl-N,N′,N′-tris(3-methyl-pyridin-2-ylmethyl)-ethylenediamine; (N-trimethylammoniumpropyl-N,N′,N′-tris(pyridin-2-ylmethyl)-ethylenediamine; (N-(2-hydroxyethylene)-N,N′,N′-tris(pyridin-2-ylmethyl)-ethylenediamine; N,N,N′,N′-tetrakis(3-methyl-pyridin-2-ylmethyl)-ethylene-diamine; N,N′-dimethyl-N,N′-bis(pyridin-2-ylmethyl)-cyclohexane -1,2-diamine; N-(2-hydroxyethylene)-N,N′,N′-tris(3-methyl-pyridin -2-ylmethyl)-ethylenediamine; N-methyl-N,N′,N′-tris(pyridin-2-ylmethyl)-ethylenediamine; N-methyl-N,N′,N′-tris(5-ethyl-pyridin-2-ylmethyl)-ethylenediamine; N-methyl-N,N′,N′-tris(5-methyl-pyridin-2-ylmethyl)-ethylenediamine; N-methyl-N,N′,N′-tris(3-methyl-pyridin-2-ylmethyl)-ethylenediamine; N-benzyl-N,N′,N′-tris (3-methyl-pyridin -2-ylmethyl)-ethylenediamine; N,N,N′-tris(3-methyl-pyridin -2-ylmethyl)-N′(2-methoxy-ethyl-1)-ethylenediamine; N,N,N′-tris(1-methyl-benzimidazol-2-yl)-N′-methyl-ethylenediamine; N-(furan-2-yl)-N,N′,N′-tris(3-methyl-pyridin-2-ylmethyl)-ethylenediamine; and, N-(2-hydroxyethylene)-N,N′,N′-tris(3-ethyl-pyridin-2-ylmethyl)-ethylenediamine.

(d) Optional Ingredients.

(d1). Detergency Builders

The enzymatic bleach compositions of the invention will generally also contain one or more detergency builders. This detergency builder may be any material capable of reducing the level of free calcium ions in the wash liquor and will preferably provide the composition with other beneficial properties such as the generation of an alkaline pH, the suspension of soil removed from the fabric and the suspension of the fabric-softening clay material. The total amount of detergency builder in the compositions will suitably range from 5 to 80%, preferably from 10 to 60% by weight. Inorganic builders that may be present include sodium carbonate, if desired in combination with a crystallisation seed for calcium carbonate, as disclosed in GB-A-1 437 950 (Unilever); crystalline and amorphous aluminosilicates, for example, zeolites as disclosed in GB-A-1 473 201 (Henkel), amorphous aluminosilicates as disclosed in GB-A-1 473 202 (Henkel) and mixed crystalline/amorphous aluminosilicates as disclosed in GB-A-1 470 250 (Procter & Gamble); and layered silicates as disclosed in EP-B-164 (Hacksawed). Inorganic phosphate builders, for example, sodium orthophosphate, pyrophosphate and tripolyphosphate, may also be present, but on environmental grounds those are no longer preferred.

The detergent compositions of the invention preferably contain an alkali metal, preferably sodium, aluminosilicate builder. Sodium aluminosilicates may generally be incorporated in amounts of from 10 to 70% by weight (anhydrous basis), preferably from 25 to 50% by weight. The alkali metal aluminosilicate may be either crystalline or amorphous or mixtures thereof, having the general formula:

0.8-1.5 Na₂O.Al₂O₃.0.8-6 SiO₂

These materials contain some bound water and are required to have a calcium ion exchange capacity of at least 50 mg CaO/g. The preferred sodium aluminosilicates contain 1.5-3.5 SiO₂ units (in the formula above). Both the amorphous and the crystalline materials can be prepared readily by reaction between sodium silicate and sodium aluminate, as amply described in the literature. Suitable crystalline sodium aluminosilicate ion-exchange detergency builders are described, for example, in GB-A-1 429 143 (Proctor & Gamble). The preferred sodium aluminosilicates of this type are the well-known commercially available zeolites A and X, and mixtures thereof. The zeolite may be the commercially available zeolite 4A now widely used in laundry detergent powders. However, according to a preferred embodiment of the invention, the zeolite builder incorporated in the compositions of the invention is maximum aluminium zeolite P (zeolite MAP) as described and claimed in EP-A-384 070 (Unilever). Zeolite MAP is defined as an alkali metal aluminosilicate of the zeolite P type having a silicon to aluminium ratio not exceeding 1.33, preferably within the range of from 0.90 to 1.33, and more preferably within the range of from 0.90 to 1.20. Especially preferred is zeolite MAP having a silicon to aluminium ratio not exceeding 1.07, more preferably about 1.00. The calcium binding capacity of zeolite MAP is generally at least 150 mg CaO per g of anhydrous material.

Organic builders that may be present include polycarboxylate polymers such as polyacrylates, acrylic/maleic copolymers, and acrylic phosphinates; monomeric polycarboxylates such as citrates, gluconates, oxydisuccinates, glycerol mono-, di- and trisuccinates, carboxymethyloxysuccinates, carboxymethyl-oxymalonates, dipicolinates, hydroxyethyl-iminodiacetates, alkyl- and alkenylmalonates and succinates; and sulphonated fatty acid salts.

Especially preferred organic builders are citrates, suitably used in amounts of from 5 to 30% by weight, preferably from 10 to 25% by weight, and acrylic polymers, more especially acrylic/maleic copolymers, suitably used in amounts of from 0.5 to 15%, preferably from 1 to 10% by weight. Builders, both inorganic and organic, are preferably present in the form of their alkali metal salt, especially their sodium salt.

(d2) Bleach Components

Detergent compositions according to the invention may additionally contain a conventional bleach system. Fabric washing compositions may desirably contain peroxy bleach compounds, for example, inorganic persalts or organic peroxyacids, capable of yielding hydrogen peroxide in aqueous solution.

Suitable peroxy bleach compounds include organic peroxides such as urea peroxide, and inorganic persalts such as the alkali metal perborates, percarbonates, perphosphates, persilicates and persulphates. Preferred inorganic persalts are sodium perborate monohydrate and tetrahydrate, and sodium percarbonate. Especially preferred is sodium percarbonate having a protective coating against destabilisation by moisture. Sodium percarbonate having a protective coating comprising sodium metaborate and sodium silicate is disclosed in GB-A-2 123 044 (Kao). The peroxy bleach compound is suitably present in an amount of from 5 to 35 wt %, preferably from 10 to 25 wt %.

The bleach system may contain apart from the hydrogen peroxide source, as disclosed above, also a peracid-forming bleach activator or precursor to improve bleaching action at low wash temperatures. Preferred bleach precursors are peroxycarboxylic acid precursors, more especially peracetic acid precursors and peroxybenzoic acid precursors; and peroxycarbonic acid precursors. Of special interest or bleach activators such as tetraacetylethylene-diamine (TAED) or N,N-phthaloylaminoperoxy caproic acid (PAP). The novel quaternary ammonium and phosphonium bleach precursors disclosed in U.S. Pat. No. 4,751,015 and U.S. Pat. No. 4,818,426 (Lever Brothers Company) and EP-A-402 971 (Unilever) are also of great interest. Alternatively, peroxycarbonic acid precursors, in particular cholyl-4-sulphophenyl carbonate can be used. Also of interest are peroxybenzoic acid precursors, in particular, N,N,N-trimethylammonium toluoyloxy benzene sulphonate; and the cationic bleach precursors disclosed in EP-A-284 292 and EP-A-303 520 (Kao). The bleach precursor is suitably present in an amount of from 1 to 8 wt %, preferably from 2 to 5 wt %.

Alternatively, inorganic peroxyacids like potassium monopersulphate (MPS) may be employed. Alkyl hydroperoxides are another class of peroxy bleaching compounds. Examples of these materials include t-butyl hydroperoxide and cumene hydroperoxide.

Optionally, bleach catalysts can be included. Such compounds are well known in the art and include, for example, manganese-based catalysts as disclosed in U.S. Pat. Nos. 5,246,621, 5,244,594, 5,194,416, 5,114,606, EP-A-458 397 and EP-A-458 398 EP-A-509 787 or the iron-based catalysts as disclosed in WO-A-95/34628.

A bleach stabilizer (heavy metal sequestrant) may also be present. Suitable bleach stabilizers include ethylenediamine tetraacetate (EDTA) and the polyphosphonates such as Dequest (Trade Mark), EDTMP.

(d3) Additional Enzymes

The bleaching detergent compositions of the present invention may additionally comprise one or more enzymes, which provide cleaning performance, fabric care and/or sanitation benefits. Such enzymes include oxidoreductases, transferases, hydrolases, lyases, isomerases and ligases. Suitable members of these enzyme classes are described in Enzyme nomenclature 1992: recommendations of the Nomenclature Committee of the International Union of Biochemistry and Molecular Biology on the nomenclature and classification of enzymes, 1992, ISBN 0-12-227165-3, Academic Press. The most recent information on the nomenclature of enzymes is available on the Internet through the ExPASy WWW server (http://www.expasy.ch/) Examples of the hydrolases are carboxylic ester hydrolase, thiolester hydrolase, phosphoric monoester hydrolase, and phosphoric diester hydrolase which act on the ester bond; glycosidase which acts on O-glycosyl compounds; glycosylase hydrolysing N-glycosyl compounds; thioether hydrolase which acts on the ether bond; and exopeptidases and endopeptidases which act on the peptide bond. Preferable among them are carboxylic ester hydrolase, glycosidase and exo- and endopeptidases. Specific examples of suitable hydrolases include (1) exopeptidases such as aminopeptidase and carboxypeptidase A and B and endopeptidases such as pepsin, pepsin B, chymosin, trypsin, chymotrypsin, elastase, enteropeptidase, cathepsin B, papain, chymopapain, ficain, thrombin, plasmin, renin, subtilisin, aspergillopepsin, collagenase, clostripain, kallikrein, gastricsin, cathepsin D, bromelain, chymotrypsin C, urokinase, cucumisin, oryzin, proteinase K, thermomycolin, thermitase, lactocepin, thermolysin, bacillolysin. Preferred among them is subtilisin; (2) glycosidases such as α-amylase, β-amylase, glucoamylase, isoamylase, cellulase, endo-1,3(4)-β-glucanase (β-glucanase), xylanase, dextranase, polygalacturonase (pectinase), lysozyme, invertase, hyaluronidase, pullulanase, neopullulanase, chitinase, arabinosidase, exocellobiohydrolase, hexosaminidase, mycodextranase, endo-1,4-β-mannanase (hemicellulase), xyloglucanase, endo-β-galactosidase (keratanase), mannanase and other saccharide gum degrading enzymes as described in WO-A-99/09127. Preferred among them are a-amylase and cellulase; (3) carboxylic ester hydrolase including carboxylesterase, lipase, phospholipase, pectinesterase, cholesterol esterase, chlorophyllase, tannase and wax-ester hydrolase.

Examples of transferases and ligases are glutathione S-transferase and acid-thiol ligase as described in WO-A-98/59028 and xyloglycan endotransglycosylase as described in WO-A-98/38288.

Examples of lyases are hyaluronate lyase, pectate lyase, chondroitinase, pectin lyase, alginase II. Especially preferred is pectolyase, which is a mixture of pectinase and pectin lyase.

Examples of the oxidoreductases are oxidases such as glucose oxidase, methanol oxidase, bilirubin oxidase, catechol oxidase, laccase, peroxidases such as ligninase and those described in WO-A-97/31090, monooxygenase, dioxygenase such as lipoxygenase and other oxygenases as described in WO-A-99/02632, WO-A-99/02638, WO-A-99/02639 and the cytochrome based enzymatic bleaching systems described in WO-A-99/02641.

A process for enhancing the efficacy of the bleaching action of oxidoreductases is by targeting them to stains by using antibodies or antibody fragments as described in WO-A-98/56885. Antibodies can also be added to control enzyme activity as described in WO-A-98/06812.

A preferred combination is a detergent composition comprising of a mixture of the lipase of the invention and conventional detergent enzymes such as protease, amylase and/or cellulase together with one or more plant cell wall degrading enzymes.

Endopeptidases (proteolytic enzymes or proteases) of various qualities and origins and having activity in various pH ranges of from 4-12 are available and can be used in the instant invention. Examples of suitable proteolytic enzymes are the subtilisins, which can be obtained from particular strains of B. subtilis, B. lentus, B. amyloliquefaciens and B. licheniformis, such as the commercially available subtilisins Savinase™, Alcalase™, Relase™, Kannase™and Everlase™ as supplied by Novo Industri A/S, Copenhagen, Denmark or Purafect™, PurafectOxP™ and Properase™ as supplied by Genencor International. Chemically or genetically modified variants of these enzymes are included such as described in WO-A-99/02632 pages 12 to 16 and in WO-A-99/20727 and also variants with reduced allergenicity as described in WO-A-99/00489 and WO-A-99/49056.

Suitable amylases include those of bacterial or fungal origin. Chemically or genetically modified variants of these enzymes are included as described in WO-A-99/02632 pages 18,19. Commercial cellulase are sold under the tradename Purastar™, Purastar OxAm™ (formerly Purafact Ox Am™) by Genencor; Termamyl™, Fungamyl™, Duramyl™, Natalase™, all available from Novozymes.

Suitable cellulases include those of bacterial or fungal origin. Chemically or genetically modified variants of these enzymes are included as described in WO-A-99/02632 page 17. Particularly useful cellulases are the endoglucanases such as the EGIII from Trichoderma longibrachiatum as described in WO-A-94/21801 and the E5 from Thermomonospora fusca as described in WO-A-97/20025. Endoglucanases may consist of a catalytic domain and a cellulose binding domain or a catalytic domain only. Preferred cellulolytic enzymes are sold under the tradename Carezyme™, Celluzyme™ and Endolase™ by Novo Nordisk A/S; Puradax™ is sold by Genencor and KAC™ is sold by Kao corporation, Japan.

Detergent enzymes are usually incorporated in an amount of 0.00001% to 2%, and more preferably 0.001% to 0.5%, and even more preferably 0.01% to 0.2% in terms of pure enzyme protein by weight of the composition. Detergent enzymes are commonly employed in the form of granules made of crude enzyme alone or in combination with other components in the detergent composition. Granules of crude enzyme are used in such an amount that the pure enzyme is 0.001 to 50 weight percent in the granules. The granules are used in an amount of 0.002 to 20 and preferably 0.1 to 3 weight percent. Granular forms of detergent enzymes are known as Enzoguard™ granules, prills, marumes or T-granules. Granules can be formulated so as to contain an enzyme protecting agent (e.g. oxidation scavengers) and/or a dissolution retardant material. Other suitable forms of enzymes are liquid forms such as the “L” type liquids from Novo Nordisk, slurries of enzymes in nonionic surfactants such as the “SL” type sold by Novo Nordisk and microencapsulated enzymes marketed by Novo Nordisk under the tradename “LDP” and “CC”.

The enzymes can be added as separate single ingredients (prills, granulates, stabilised liquids, etc. containing one enzyme) or as mixtures of two or more enzymes (e.g. cogranulates). Enzymes in liquid detergents can be stabilised by various techniques as for example disclosed in U.S. Pat. Nos. 4,261,868 and 4,318,818.

The detergent compositions of the present invention may additionally comprise one or more biologically active peptides such as swollenin proteins, expansins, bacteriocins and peptides capable of binding to stains.

(d4) Further Optional Ingredients

The compositions of the invention may contain alkali metal, preferably sodium, carbonate, in order to increase detergency and ease processing. Sodium carbonate may suitably be present in amounts ranging from 1 to 60 wt %, preferably from 2 to 40 wt %. However, compositions containing little or no sodium carbonate are also within the scope of the invention.

Powder flow may be improved by the incorporation of a small amount of a powder structurant, for example, a fatty acid (or fatty acid soap), a sugar, an acrylate or acrylate/maleate polymer, or sodium silicate. One preferred powder structurant is fatty acid soap, suitably present in an amount of from 1 to 5 wt %.

The detergent compositions according to the present invention may also comprise from 0. 001% to 10%, more preferably from 0.01% to 2%, more preferably from 0.05% to 1% by weight of polymeric dye transfer inhibiting agents. Said polymeric dye transfer inhibiting agents are normally incorporated into detergent compositions in order to inhibit the transfer of dyes from colored fabrics onto fabrics washed therewith. These polymers have the ability to complex or adsorb the fugitive dyes washed out of dyed fabrics before the dyes have the opportunity to become attached to other articles in the wash. Especially suitable polymeric dye transfer inhibiting agents are polyamine N-oxide polymers, copolymers of N-vinylpyrrolidone and N-vinylimidazole, polyvinylpyrrolidone polymers, polyvinyloxazolidones and polyvinylimidazoles or mixtures thereof.

Soil release agents useful in compositions of the present invention are conventionally copolymers or terpolymers of terephthalic acid with ethylene glycol and/or propylene glycol units in various arrangements. Examples of such polymers are disclosed in the commonly assigned U.S. Pat. Nos. 4,116,885 and 4,711,730 and EP-A-272 033.

Other materials that may be present in detergent compositions of the invention include sodium silicate; antiredeposition agents such as cellulosic polymers; inorganic salts such as sodium sulphate, lather control agents or lather boosters as appropriate, enzyme stabilizers, corrosion inhibitors, dyes, coloured speckles, perfumes, suds depressants, germicides, anti-tarnishing agents, opacifiers, optical brighteners, foam controllers, and fabric softening compounds. This list is not intended to be exhaustive.

The invention will now be further illustrated in the following Examples.

### EXAMPLE 1

Bleaching of Tomato-Oil Stained Cotton Cloths Without and With Addition of Various Metal Catalysts and Lipolase.

The potential for Lipolase to boost the bleaching performance of various metal catalysts was assessed by washing cotton swatches soiled with tomato-oil stains Tomato/soy oil stained cloths were added and stirred for 30 minutes at 25° C. (blanks) in the following detergent composition dosed at 2 g/l in Milli-Q water with 0.6 mM CaCl₂ added. Cloth to liquor ratio was 1:40. The pH of the wash solution was 10 at the start of the wash.

| Detergent Composition: | |
|---|---|
| Anionic surfactant (LAS) | 23% |
| Cationic surfactant (Praepagen HY) | 0.83% |
| STPP (Sodium Tripolyphosphate) | 14.5% |
| Sodium silicate | 7.2% |
| Sodium sulphate | 30.0% |
| Sodium carbonate | 17.5% |
| SCMC (Sodium Carboxymethyl Cellulose) | 0.38% |
| Tinopal CBS-X (ex. Ciba-Geigy) | 0.06% |
| Tinopal DMS (ex. Ciba-Geigy) | 0.11% |
| Dye CI74160 | 0.02% |
| Termamyl 60 T (amylase ex. Novozymes A/S) | 0.28% |
| Savinase 12 T (protease ex. Novozymes) | 0.47% |
| Moisture | 5.47% |

In comparative experiments, the same tests were done in the presence of 5 μM of transition metal complex, referred to in the table below. Either no lipase was added or 1 mg/l protein of Lipolase 100T, a commercial lipase ex. Novo Nordisk or 1 mg/l protein of a cutinase from Fusarium solani pisi as described in WO-A-94/3578 (Unilever). The lipases were pre-dissolved in 10 mM Tris(hydroxymethyl)-aminoethane+50 mM NaCl+0.4 mM CaCl₂ adjusted to pH 8.0 with HCl. This stock solution was diluted 6× when added to the wash solution. For the control wash without lipase a similar amount of the 10 mM Tris-buffer was added to avoid pH differences between wash solutions. The transition metal complexes were pre-dissolved in Milli-Q water or in mixtures of organic solvent (ethanol, methanol, dichloromethane) and water to a concentration of 2.25 mM. These stock solutions are diluted 30× with Milli-Q water and then another 15× when added to the wash solutions.

After the wash, the cloths were rinsed two times for 1 minute at 22° C. with 50 mM NaH₂PO₄ buffer pH 5.0 (cloth:liquor=1:40) and subsequently dried at 37° C. and the change in colour was measured with a Linotype-Hell scanner (ex Linotype). The change in colour was measured 2 hours after the wash (immediately after drying) and after 24 hours storage in a dark room under ambient conditions. The change in colour (including bleaching) is expressed as the ΔE value. The measured colour difference (ΔE) between the washed stained cloth and clean, unstained cotton is defined as follows:

ΔE=\sqrt{ΔL²+Δa²+Δb²}

wherein ΔL is a measure for the difference in darkness between the washed and clean test cloth; Δa and Δb are measures for the difference in redness and yellowness respectively between both cloths. With regard to this colour measurement technique, reference is made to Commission International de l'Eclairage (CIE); Recommendation on Uniform Colour Spaces, colour difference equations, psychometric colour terms, supplement no 2 to CIE Publication, no 15, Colormetry, Bureau Central de la CIE, Paris 1978.

The following transition metal complexes were used:

1. [Fe(N4py) (CH₃CN)] (ClO₄)₂

2. [Fe(MeN4Py)Cl]Cl

3. [FeLCl]Li₂

4. [Fe(Metrilen)Cl]PF₆

5. [Fe(FuranylTrilen)Cl]PF₆

6. [Fe(Bztrilen)Cl]PF₆

7. [Fe(L′)Br]ClO₄

8. [Mn (bispicenMe₂) Cl₂]

9. [Mn₂(tpa)₂(μ-O)₂] (ClO₄)₃. Of this compound 2.5 μM was added in stead of 5 μM.

These complexes were synthesised as follows:

1. [Fe(N4py) (CH₃CN)] (ClO₄)₂ (N4py=(N,N-bis(pyridin-2-yl-methyl)-1,1-bis(pyridin-2-yl)-aminomethane)

Compound 1 was synthesised as decribed in WO-A-95/34628 (Unilever).

2. FeMeN4pyCl2

N,N-bis(pyridin-2-yl-methyl)-1,1-bis(pyridin-2-yl)-1-aminoethane, MeN4Py, was prepared according to the procedure described in EP-A-909 809 (Unilever). MeN4Py ligand (33.7 g; 88.5 mmoles) was dissolved in 500 ml dry methanol. Small portions of FeCl₂.4H₂O (0.95 eq; 16.7 g; 84.0 mmoles) were added, yielding a clear red solution. After addition, the solution was stirred for 30 minutes at room temperature, after which the methanol was removed (rotary-evaporator). The dry solid was ground and 150 ml of ethylacetate was added and the mixture was stirred until a fine red powder was obtained. This powder was washed twice with ethyl acetate, dried in the air and further dried under vacuum (40° C.). El. Anal. Calc. for [Fe(MeN4py)Cl]Cl.2H₂O: C 53.03; H 5.16; N 12.89; Cl 13.07; Fe 10.01%. Found C 52.29/52.03; H 5.05/5.03; N 12.55/12.61; Cl: 12.73/12.69; Fe: 10.06/10.01%.

3. [FeLCl]Li₂

The ligand L (1H-1,4,8,11-Benzotetraazacyclotridecine -2,5,7,10(6H,11H) tetrone, 13,14-dichloro-6,6-diethyl -3,4,8,9-tetrahydro-3,3,9,9-tetramethyl)was synthesised as described in literature (T. J. Collins et al., J. Am. Chem. Soc. (1991), 113(22), 8419-25). The iron complex was prepared as described elsewhere in WO-A-98/03625 (Carnegie-Mellon University), using lithium salt as counter ion.

4. [Fe(Metrilen)Cl]PF₆ (Metrilen=N-methyl-N,N′,N′-tris(3-methyl-pyridin-2-ylmethyl)-ethylenediamine). This compound was synthesised as described in WO-A-00/27976 (Unilever).

5. [Fe(Fe(N-(furan-2-yl)-N,N′,N′-tris(3-methyl-pyridin-2-ylmethyl)-ethylenediamin)Cl]PF₆.

This compound was synthesised as described in WO-A-00/60043 (Unilever).

6. [Fe(Bztrilen)Cl]PF₆ (Bztrilen=N-benzyl-N,N′,N′-tris(3-methyl-pyridin-2-ylmethyl)-ethylenediamine). This compound was synthesised as described in WO-A-00/27976 (Unilever).

7. [Fe(L′)Br]ClO4 with L′=1,4-bis(quinolin-2-ylmethyl) -7-ethyl-1,4,7-triazacyclononane.

This compound was synthesised as follows:

1,4,7-triazacyclononane

Ligand 1,4,7-triazacyclononane was produced according the modified method used by the team of Prof. Wieghardt. In this method the detosylation of the 1,4,7-tris-p-toluenesulfon -1,4,7-triazacylononanamide is performed in 5 minutes in hot sulphuric acid of 180° C. Once the solution has cooled down it is transferred into ether under vigorous stirring. The solution that surfaces is decanted and the residue is dissolved in some boiling water. At boiling temperature drops of concentrated hydrochloric acid are added. The brown crystals that precipitate are drained off and washed with cold hydrochloric acid and then with ethanol and ether. The 1,4,7-triazacyclononane. trihydrochloride thus produced is then processed further as described by Wieghardt et al (K. Wieghardt et al, Chem Ber., 112, 2200 (1979)).

1,4,7-triazatricyclo[5.2.1.0⁴¹⁰]decane (orthoamide) 0.5 mol 1,4,7-triazacyclononane, 64.3 g, 0.54 mol orthoformicacidtriethylester, 74.8 g, and 20 mmol p-toluolsulphonacid, 4 g, are heated to 150° C. The ethanol that is created and some of the esters are distilled off. After the reaction has been completed the orthoamide can be distilled off at a pressure of <80 mbar in the form of a bright yellow volatile oil (b.p. 350 K at 133 Pa), in agreement with literature (T. J. Atkins, J. Am. Chem. Soc., 102, 6365 (1980)).

1-ethyl-1,4,7-triazacyclononane (Et-tacn)

Into a mixture of 0.1 mol orthoamide, 13.92 g, dissolved in dry THF, slowly 0.1 mol ethylbromide, 10.9 g, is dripped. The suspension is stirred for 2 days at room temperature in a closed flask. The microcrystalline powder is drained off and washed with some dry THF. The resulting bromide salt is very hygroscopic. The salt is dissolved in 80 ml water and boiled for 4 hours under back-flow. Then 16 g sodium hydroxide dissolved in 20 ml water is added. This creates a 4 molar reaction mixture. Immediately, a bright yellow oil is separated. To complete the reaction, boiling is continued for another 20 hours. After cooling down 300 ml toluol is added and the water is distilled off by means of a water separator. The reaction mixture is filtered and the toluol is drained off by a rotary evaporator. The remaining product is a bright yellow oil.

Yield: 13.8 g (89%). ¹H-NMR (CDCl₃-270 MHz; 300K): 2.59-2.39 (m; 14H); 1.83 (s, 2H); 0.90 ppm (t; 3H); ¹³C-NMR: 52.1; 50.7; 46.5; 46.4; 12.4 ppm.

Quinolin-2-ylmethylbromide

The quinolinemethylbromide is produced as follows. In this method 0.2 mol quinoline (30.0 g) with 0.22 mol N-bromsuccinimid (42 g) and dibenzoylperoxide as starter are placed in 300 ml freshly distilled benzene under irradiation of light. The succinimid that is sedimented after strong cooling is filtered off and the benzene is rotated off. The remaining oil is put into 5% hydrobromic acid. Under cooling with ice a saturated solution of sodiumcarbonate is added to the watery solution up to a pH-value of 7. The precipitated yellowish product is drained off and recrystallized from pentane.

1,4-bis(quinolin-2-ylmethyl)-7-ethyl-1,4,7-triazacyclononane

20 mmol Et-tacn (3.12 g) is dissolved in 50 ml dry THF and diluted with 8 ml triethylamine (56.8 mmol). Then 40 mmol quinolin-2ylmethylbromide (8.96 g) is added, after which the solution turns brown. The reaction mixture is stirred for 3 days. The resulting triethylammoniumbromide is filtered off and the THF is rotated off. What remains is a red to brown oil. The by-products (approx. 8%) created by the alkaline hydrolysis of the chinolylmethylbromide could not be separated by HPLC, GC or chromatography, the ligand analysed.

Yield: 6.6 g (75%). ¹H-NMR (CDCl₃-400 MHz; 300K): 7.92 (d;2H); 7.89 (d;2H); 7.62 (d;2H); 7.52 (d;2H); 7.50 (m;2H); 7.34 (m;2H); 3.87 (s;4H); 2.94 (m;4H); 2.88 (m;4H); 2.68 (m;4H); 2.53 (q;2H); 0.92 ppm (t; 3H); ¹³C-NMR: 160.2; 147.1; 135.9; 129.0; 128.5; 127.2; 127.0; 125.8; 121.1; 64.9; 55.3; 54.3; 53.6; 51.1; 11.8 ppm. MS (EI): 439 (M⁺; rel int 20%; 157 (rel int. 40%-quinoline -2carboxaldehyde); 143 (rel int 100%-quinoline).

[Fe(1,4-bis(quinolin-2-ylmethyl)-7-ethyl-1,4,7-triazacyclononane)Br] (ClO₄):

Dissolve 1 mmol 1,4-bis(quinolin-2-ylmethyl)-7-ethyl -1,4,7-triazacyclononane, 0.44 g, in 30 ml methanol (bright yellow) and lead through argon. Add 1 mmol FeBr₂ (0.22) g. Heat the reaction mixture for 2 hours under back-flow and argon atmosphere. An orange solution is produced. The solution is filtered via an argon frit under protective gas atmosphere to remove undissolved iron bromide. Sodium perchlorate is added to the filtrate and stirred for 2 hours at room temperature. An orange solid is produced. This can be drained off quickly by air and washed with ether. The product is air-stable.

Yield: 400 mg (59%). Elem. Anal. Found: C: 48.24; H: 4.63; N: 10.02%. Calc.: C: 49.85; H: 4.89; N: 10.38%

8. [Mn(bispicenMe₂)Cl₂]

This compound was synthesised as described in WO-A-00/12667 (Unilever).

9. [Mn₂(tpa)₂(μ-O)₂] (ClO₄)₃

This compound was synthesised according to the procedure described by D. K. Towle, et al using sodium perchlorate for crystallisation. (ref: D. K. Towle, C. A. Botsford, D. J. Hodgson, ICA, 141, 167 (1988).

Every wash experiment was repeated at least 8×. Results are calculated as average ΔE values versus white and compared to each other using SAS statistical analysis software. Results, as average ΔE, are shown in Table 1a below. A lower value means a better result. The experimental standard deviation is 0.74. Synergy between metal complex and lipase was also assessed using SAS software (Table 1b). Over the entire data set (N=272) the least significant difference for a 95% confidence interval for the interaction term is 0.18. Table 1 shows the Stain bleach performance of detergent with and without transition metal complexes and with and without Lipolase on tomato oil stains.

TABLE 1a
Tomato/oil stains on cotton.
Stain residue (after wash) compared to clean cotton in ΔE.

| CATALYST | BLANK | BLANK | LIPOLASE | LIPOLASE | CUTINASE | CUTINASE |
|---|---|---|---|---|---|---|
| Response after (hours) | 2 | 24 | 2 | 24 | 2 | 24 |
| Blank | 21.54 | 21.78 | 20.86 | 20.88 | 21.71 | 21.89 |
| [Fe(L′)Br]ClO4 | 15.06 | 13.56 | 14.21 | 12.72 | 15.18 | 13.56 |
| [Fe(Bztrilen)Cl]PF₆ | 19.23 | 18.89 | 18.41 | 16.86 | 19.70 | 19.29 |
| [Fe(N4py)(CH₃CN)](ClO₄)₂ | 21.50 | 21.53 | 19.99 | 19.39 | 21.36 | 21.40 |
| [Fe(Metrilen)Cl]PF₆ | 20.72 | 20.84 | 19.76 | 19.48 | 20.63 | 20.74 |
| [Fe(FuranylTrilen)Cl]PF₆ | 19.75 | 19.19 | 18.91 | 17.84 | 19.74 | 19.39 |
| [Fe(MeN4Py)Cl]Cl | 20.48 | 17.97 | 18.78 | 14.57 | 20.32 | 17.77 |
| [FeLCl]Li₂ | 22.17 | 22.41 | 21.44 | 21.31 | 22.14 | 22.33 |
| [Mn(bispicenMe₂)Cl₂] | 22.39 | 22.47 | 21.23 | 21.00 | 22.36 | 22.33 |
| [Mn₂(tpa)₂(μ-O)₂](ClO₄)₃ | 21.94 | 22.07 | 20.60 | 20.45 | 21.98 | 22.08 |

TABLE 1B
Lipase and catalyst effects on tomato/oil stains.
Significant synergistic effects (*** = 99% and * = 95%).

CATALYST

| | LIPO- | LIPO- | CUTI- | CUTI- |
|---|---|---|---|---|
| response after | LASE | LASE | NASE | NASE |
| (hours) | 2 | 24 | 2 | 24 |
| [Fe(L′)Br]ClO4 | | | | |
| [Fe(Bztrilen)Cl]PF₆ | | * | | |
| [Fe(N4py)(CH₃CN)](ClO₄)₂ | * | *** | * | |
| [Fe(Metrilen)Cl]PF₆ | | * | | |
| [Fe(FuranylTrilen)Cl | | * | | |
| ]PF₆ | | | | |
| [Fe(MeN4Py)Cl]Cl | *** | *** | * | |
| [FeLCl]Li₂ | | | | |
| [Mn(bispicenMe₂)Cl₂] | * | * | | |
| [Mn₂(tpa)₂(μ- | * | * | | |
| O)₂](ClO₄)₃ | | | | |

As can be seen from the ΔE values, the bleaching of the tomato oil stains is best if both Lipolase and a metal complex are present. In many cases a synergistic effect is seen between stain removal by Lipolase and the metal complex.

### EXAMPLE 2

Bleaching of Tomato-Oil and Curry-Oil Stained Cotton Cloths Without and With Addition of Various Lipases and Metal Catalysts.

The potential for various lipases to boost the bleaching performance of various metal catalysts was assessed by washing cotton swatches soiled with tomato/soy oil and with curry/soy oil stains as described in example 1.

The following detergent composition was used at 1 g/l in Milli-Q water with 0.4 mM CaCl₂ added. Cloth to liquor ratio was 1:40. The pH of the fresh wash solution was 10. After the wash the pH had dropped to about 8. This effect was studied in more detail in example 4.

| Detergent Composition: | |
|---|---|
| Na-LAS | 24.8% |
| Silicate | 10.2% |
| STPP | 30.8% |
| Sodium Sulphate | 21.4% |
| Sodium Carbonate | 12.0% |
| Savinase 12 T | 0.77% |

The following complexes were used:

2. [Fe(MeN4Py)Cl]Cl

4. [Fe(Metrilen)Cl]PF₆

6. [Fe(Bztrilen)Cl]PF₆

The following commercially available lipases were used:

1. L8525 from Candida rugosa ex. Sigma-Aldrich

2. L0763 Type XII from Chromobacterium viscosum ex. Sigma-Aldrich

3. L9031 from Rhizomucor miehei ex. Sigma-Aldrich

4. L0382 Type VI-S from porcine pancreas ex. Sigma-Aldrich

5. L9156 from Pseudomonas cepacia ex. Sigma-Aldrich

6. L4384 Type XI from Rhizopus arrhizus ex. Sigma-Aldrich

7. Lipolase 100T ex. Novo Nordisk

8. Lipolase ultra ex. Novo Nordisk

9. LipoPrime 50T ex. Novo Nordisk

10. Lipomax 500G ex. Genencor International

In addition two enzymes, not commercially available were used:

11. Cutinase from Fusarium solani pisi as described in WO-A-94/3578 (Unilever).

12. Lumafast 2000G a lipase sold in the past by Genencor International, which is believed to be the lipase from Pseudomonas mendocina as described in U.S. Pat. No. 5,389,536 to Genencor Inc.

All lipases were added to the wash solution at equal activity of 10 KLU/l. The lipolytic activity was determined according to the standard tributyrin method as described in the Novo SOP EB-SM-0095.02/01. Lipolase 100T, batch PPW 5593, with a nominal activity of 101 KLU/g was used as the reference lipase.

In comparative experiments, the same tests were done in the presence of 5 μM of transition metal complex, referred to in the table below. Either no lipase was added or 10 KLU/l of one of the above lipases.

The experiment was further carried out and analysed as described in example 1, except that colour was measured either after 2 hours or after 3 days after the wash. For ease of comparison for curry oil only the data after 3 days and for tomato oil only the data after 2 hours are shown. Experiments with tomato oil stains were repeated 8×; experiments with curry oil stains were repeated 2×.

Table 2 shows the Stain bleach performance of detergent with and without transition metal complexes and with and without lipase on curry oil stains. The experimental standard deviation was 1.1. Over the entire data set (N=70) the least significant difference for a 95% confidence interval for the interaction term on curry oil is 0.53.

TABLE 2A
Curry/oil stains on cotton (response after 3 days)
Stain residue (after wash) compared to clean cotton in ΔE.

| LIPASE | No metal complex | [Fe(MeN4py)Cl]Cl | [Fe(Metrilen)Cl]PF₆ | [Fe(Bztrilen)Cl]PF₆ |
|---|---|---|---|---|
| Blank | 66.77 | 57.84 | 60.10 | 59.54 |
| L4384 (Rhizopus | 66.83 | 56.05 | 58.36 | 58.34 |
| arrhizus) | | | | |
| Lipoprime 50 T | 66.28 | 53.26 | 57.26 | 56.13 |
| Cutinase | 66.11 | 57.21 | 59.30 | 60.09 |
| Lipomax 500 G | 66.11 | 54.61 | 58.54 | 57.88 |
| Lumafast 2000 G | 66.22 | 57.19 | 59.72 | 61.00 |
| L9031 (Rhizomucor | 66.40 | 55.36 | 58.42 | 58.18 |
| miehei) | | | | |
| L9156 (Ps. cepacia) | 65.68 | 57.04 | 59.28 | 59.81 |
| L8525 (Candida | 65.58 | 57.20 | 59.13 | 58.41 |
| rugosa) | | | | |
| LC763 | 64.75 | 55.51 | 57.22 | 57.34 |
| (Chromobacterium | | | | |
| viscosum) | | | | |
| L0382 (porcine | 65.46 | 57.10 | 59.21 | 59.75 |
| pancreas) | | | | |
| Lipolase 100 T | 65.86 | 52.46 | 56.37 | 52.05 |
| Lipolase ultra 50 T | 64.88 | 52.69 | 56.20 | 53.01 |

TABLE 2B
Lipase and catalyst effects on curry/oil stains.
Significant synergistic effects (*** = 99% and * = 95%).
Significant antagonistic effects (--- = 99% and - = 95%).

| LIPASE | [Fe(MeN4py)Cl]Cl | [Fe(Metrilen)Cl]PF₆ | [Fe(Bztrilen)Cl]PF₆ |
|---|---|---|---|
| L4384 (Rhizopus arrhizus) | * | * | * |
| Lipoprime 50 T | *** | *** | *** |
| Cutinase | | | - |
| Lipomax 500 G | *** | | |
| Lumafast 2000 G | | | --- |
| L9031 (Rhizomucor miehei) | *** | * | |
| L9156 (Ps. Cepacia) | | | - |
| L8525 (Candida rugosa) | | | |
| L0763 (Chromobacterium viscosum) | | | |
| L0382 (porcine pancreas) | | | - |
| Lipolase 100 T | *** | *** | *** |
| Lipolase ultra 50 T | *** | *** | *** |

Tbale 3 shows the stain bleach performance of detergent with and without transition metal complexes and with and without lipase on tomato oil stains. The experimental standard deviation is 1.1. Over the entire data set (N=278) the least significant difference for a 95% confidence interval for the interaction term on tomato oil is 0.26.

TABLE 3A
Tomato/oil stains on cotton (response after 2 hours)
Stain residue (after wash) compared to clean cotton in ΔE.

| LIPASE | No metal complex | [Fe(MeN4py)Cl]Cl | [Fe(Metrilen)Cl]PF₆ | [Fe(Bztrilen)Cl]PF₆ |
|---|---|---|---|---|
| Blank | 25.63 | 17.95 | 23.80 | 18.54 |
| L4384 (Rhizopus | 25.88 | 16.07 | 24.48 | 18.16 |
| arrhizus) | | | | |
| Lipoprime 50 T | 25.97 | 15.63 | 24.52 | 18.48 |
| Cutinase | 25.95 | 18.39 | 24.80 | 19.56 |
| Lipomax 500 G | 25.33 | 16.09 | 25.27 | 19.53 |
| Lumafast 2000 G | 25.00 | 18.15 | 23.64 | 18.91 |
| L9031 (Rhizomucor | 25.47 | 15.15 | 24.11 | 17.49 |
| miehei) | | | | |
| L9156 (Ps. | 25.62 | 17.73 | 24.15 | 18.71 |
| Cepacia) | | | | |
| L8525 (Candida | 25.98 | 18.32 | 24.88 | 19.17 |
| rugosa) | | | | |
| L0763 | 26.14 | 17.33 | 24.54 | 18.07 |
| (Chromobacterium | | | | |
| viscosum) | | | | |
| L0382 (porcine | 26.50 | 18.81 | 24.98 | 18.67 |
| pancreas) | | | | |
| Lipolase 100 T | 25.78 | 15.46 | 25.18 | 17.25 |
| Lipolase ultra 50 T | 25.23 | 14.88 | 25.07 | 17.01 |

TABLE 3B
Lipase and catalyst effects on tomato/oil stains.
Significant synergistic effects (*** = 99% and * = 95%).
Significant antagonistic effects (--- = 99% and - = 95%).

| LIPASE | [Fe(MeN4py)Cl]Cl | [Fe(Metrilen)Cl]PF₆ | [Fe(Bztrilen)Cl]PF₆ |
|---|---|---|---|
| L4384 (Rhizopus arrhizus) | *** | | * |
| Lipoprime 50 T | *** | | |
| Cutinase | | - | - |
| Lipomax 500 G | *** | --- | --- |
| Lumafast 2000 G | - | | --- |
| L9031 (Rhizomucor miehei) | *** | | *** |
| L9156 (Ps. Cepacia) | | | |
| L8525 (Candida rugosa) | | --- | |
| L0763 (Chromobacterium viscosum) | *** | | * |
| L0382 (porcine pancreas) | | | * |
| Lipolase 100 T | *** | --- | *** |
| Lipolase ultra 50 T | *** | --- | *** |

As can be seen from the ΔE values, the bleaching of the tomato oil and curry oil stains is best if both a lipase and a metal complex are present. In many cases a synergistic effect is seen between stain removal by the lipase and the metal complex. The synergistic effect is larger for the fungal lipases such as L4384 (Rhizopus arrhizus), LipoPrime, Lipolase ultra, Lipolase (all originating from Humicola lanuginosa) and L9031 (Rhizomucor miehei)

### EXAMPLE 3

Bleaching of Tomato-Oil and Curry-Oil Stained Cotton Cloths Without and With Addition of Various Lipases and Metal Catalysts in Various Detergent Formulations.

The potential for various lipases to boost the bleaching performance of various metal catalysts was assessed by washing cotton swatches soiled with tomato-oil and with curry-oil stains as described in examples 1 and 2. The following detergent compositions were used (in weight %)

| | Detergent code | | | |
|---|---|---|---|---|
| Ingredient name | A | B | C | D |
| Anionic surfactant (LAS) | 24.8 | 17.3 | 17.3 | 15.3 |
| Nonionic surfactant (Synperonic | 0 | 7.5 | 7.5 | 6.6 |
| A7) | | | | |
| Silicate | 10.2 | 10.1 | 10.1 | 8.9 |
| STPP | 30.7 | 31.1 | 31.1 | 27.5 |
| Sodium sulphate | 21.3 | 21.3 | 21.3 | 18.9 |
| Sodium carbonate | 12.0 | 12.4 | 12.4 | 11.0 |
| Sodium percarbonate | 0 | 0 | 0 | 6.9 |
| TAED (83%) | 0 | 0 | 0 | 2.0 |
| Dequest 2047 | 0 | 0 | 0 | 2.3 |
| Savinase 12 T | 1 | 0.3 | 0.3 | 0.7 |
| PH (adjusted with HCl) | 10.0 | 10.0 | 9.0 | 9.0 |

Above detergents were dosed at

1 g/l detergent A in Milli-Q water with 0.4 mM CaCl₂;

3 g/l detergent B in Milli-Q water with 2.0 mM CaCl₂;

3 g/l detergent C in Milli-Q water with 0.8 mM CaCl₂;

3 g/l detergent D in Milli-Q water with 0.8 mM CaCl₂.

[Fe(MeN4Py)Cl]Cl transition metal complex was used at 7.7 μM. Lipases were added at 10 mg/l enzyme protein. The experiment was further carried out and analysed as described in examples 1-3, except that colour was measured 24 hours after the wash.

A clear stain removal benefit was observed for having both a metal complex and a lipase (preferably Lipolase and Lipolase variants) in above detergents A,B,C,D. To illustrate the effect the difference was calculated between stain removal by lipase in the absence (none) and in the presence of [Fe(MeN4Py)Cl]Cl. As is shown in table 4 for curry oil, the lipase effect is much bigger in the presence of the metal complex.

TABLE 4
Curry/oil stains on cotton (response after 24 hours).
Enzyme effect in ΔE. A lower value is a better result.

| | | Detergent | | | |
|---|---|---|---|---|---|
| Enzyme | Catalyst | A | B | C | D |
| LipoPrime | None | 1.18 | 0.68 | −1.69 | 1.65 |
| 50T | | | | | |
| LipoPrime | [Fe(MeN4Py)Cl]Cl | −5.09 | −9.14 | −9.20 | −9.28 |
| 50T | | | | | |
| Lipolase | None | −0.65 | 0.38 | −1.68 | −0.48 |
| ultra 50T | | | | | |
| Lipolase | [Fe(MeN4Py)Cl]Cl | −7.46 | −8.31 | −6.44 | −5.35 |
| ultra 50T | | | | | |
| Lipolase | None | 0.42 | −1.08 | 0.58 | 0.45 |
| 100T | | | | | |
| Lipolase | [Fe(MeN4Py)Cl]Cl | −7.01 | −9.18 | −6.43 | −5.90 |
| 100T | | | | | |
| Lumafast | None | 0.71 | 0.46 | 0.17 | 0.05 |
| 2000G | | | | | |
| Lumafast | [Fe(MeN4Py)Cl]Cl | −0.45 | −0.27 | −1.33 | 0.36 |
| 2000G | | | | | |

### EXAMPLE 4

Bleaching of Tomato-Oil and Curry-Oil Stained Cotton Cloths Without and With Addition of Lipolase and Metal Catalysts.

The synergistic cleaning effect of Lipolase and [Fe(MeN4Py)Cl]Cl as observed in example 2 on tomato/oil and curry/oil stains was repeated. The washing experiment was performed in a detergent composition as described in Example 2 dosed at 1 g/l in Milli-Q water with 0.4 mM CaCl₂ and ambient temperature (about 22° C.). The concentration of Lipolase was 1 mg protein per liter and of the metal complex 5 μM. Cloth to liquor ration was 1:65. After the wash the stains were rinsed with excess tap water (16° FH with Ca²⁺:Mg²⁺=4:1). The curry oil stains were given a final 5 minute rinse with 50 mM sodiumphosphate buffer pH 5. The rinsed cloths were tumble dried at low temperature. Stains were measured before the wash and immediately after drying. The stain removal was expressed in ΔE, calculated from the chromatic factors L*, a* and b* of the stains after and before the wash. The cleaning effects are given in Table 5. Because the ΔE in this experiment is expressed as difference between after the wash and before the wash a bigger number means a better result. Data are shown as the average of 3 repeats. The experimental standard deviation on tomato oil=2.9 (df 8) and on curry oil=1.7 (df 8).

TABLE 5A
Stain removal of Lipolase and [Fe(MeN4py)Cl]Cl in 1 g/l
detergent.

| | Curry/oil | Tomato/oil |
|---|---|---|
| Control | 17.5 | 22.4 |
| Lipolase | 19.8 | 20.4 |
| [Fe(MeN4py)Cl]Cl | 23.8 | 24.4 |
| Lipolase + [Fe(MeN4py)Cl]Cl | 35.8 | 24.7 |

Since a low detergent dosage of 1 g/l was used the addition of Lipolase in Tris-Cl buffer, the lipase activity and the dissolution of the stain may influence the pH of the wash solution. Therefore in this experiment the pH of the suds was measured immediately after the wash (Table 5).

TABLE 5B
pH of the wash solution at the end of the wash

| | Curry/oil | Tomato/oil |
|---|---|---|
| Control | 8.6 | 9.5 |
| Lipolase | 7.6 | 8.8 |
| [Fe(MeN4py)Cl]Cl | 7.8 | 9.2 |
| Lipolase + [Fe(MeN4py)Cl]Cl | 7.6 | n.d. |

(n.d. = not determined)

The initial pH of the detergent solution was 9.98. As is clear the pH of the wash solution drops in particular for the tomato oil stains. However, this drop cannot explain the marked synergy between the catalyst and the lipase. It is expected that the drop in pH is less for the other detergent formulations used in Examples 1 and 3.

1. An enzymatic detergent composition which comprises:
(a) surfactant;
(b) 10-20,000 LU per gram of the detergent composition of a lipase selected from the group consisting of a lipase obtainable from Humicola lanuginosa, Pseudomonas seudoalcaligenes, and Rhizomucor miehei; and
(c) a non-cross-bridged polydentate N-donor ligand capable of forming a complex with a transition metal, wherein said complex is capable of catalysing the bleaching of stains on fabrics by means of atmospheric oxygen.

2. A detergent composition according to claim 1, wherein the lipase is from Humicola lanuginosa strain DSM4109.

3. A detergent composition according to claim 1, wherein the ligand is defined by the general formula (I) or an transition metal complex thereof, preferably iron, manganese, copper or cobalt, 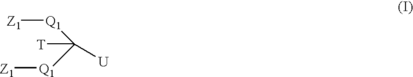
wherein:
Z₁ groups independently represent a coordinating group selected from an optionally substituted heteroaromatic ring being selected from pyridine, pyrimidine, pyrazine, pyrazole, imidazole, benzimidazole, quinoline, quinoxaline, triazole, isoquinoline, carbazole, indole, isoindole, oxazole and thiazole;
Q₁ is [CR1R2]ₙ with R1, and R2 each inpendently selected from from hydrogen, hydroxyl, halogen, —R and —OR, wherein R represents alkyl, alkenyl, cycloalkyl, heterocycloalkyl, aryl, heteroaryl or a carbonyl derivative group with n=1 or 2;
T represents a non-coordinated group selected from hydrogen, hydroxyl, halogen, —R and —OR, wherein R represents alkyl, alkenyl, cycloalkyl, heterocycloalkyl, aryl, heteroaryl or a carbonyl derivative group, R being optionally substituted by one or more functional groups E;
U represents a coordinating group of the general formula (II), (III) or (IV): 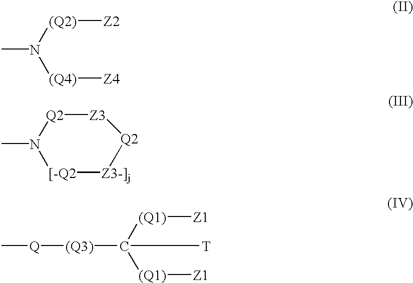
wherein:
Q2 and Q4 are independently defined as for Q1; and
Q represents —N(T)— (wherein T is independently defined as above), or an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole;
Z2 is independently defined as for Z1;
Z3 groups independently represent —N(T)— (wherein T is independently defined as above);
Z4 represents a coordinating or non-coordinating group selected from hydrogen, hydroxyl, halogen, —NH—C(NH)NH₂, —R and —OR, wherein R=alkyl, alkenyl, cycloalkyl, heterocycloalkyl, aryl, heteroaryl or a carbonyl derivative group, R being optionally substituted by one or more functional groups E, or Z4 represents a group of the general formula (IIa): 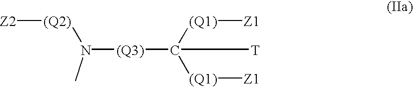
and
1≦j<4.

4. A detergent composition according to claim 3, wherein the Z1, Z2 and Z4 independently represent groups selected from optionally substituted pyridin-2-yl, optionally substituted imidazol-2-yl, optionally substituted imidazol-4-yl, optionally substituted pyrazol-1-yl, and optionally substituted quinolin-2-yl.

5. A detergent composition according to claim 3, wherein Z1, Z2 and Z4 each represent optionally substituted pyridin-2-yl.

6. A detergent composition according to claim 3, wherein the Z1 groups represent identical groups.

7. A detergent composition according to claim 3, wherein each Q3 represents a covalent bond or C1-C4-alkylene, preferably a covalent bond.

8. A detergent composition according to claim 3, wherein T represents hydrogen, hydroxy, methyl, ethyl, benzyl, or methoxy.

9. A detergent composition according to claim 3, wherein Z2 represents an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole, preferably optionally substituted pyridin-2-yl or optionally substituted benzimidazol-2-yl, and wherein Z4 represents an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole, preferably optionally substituted pyridin-2-yl, or an non-coordinating group selected from hydrogen, hydroxy, alkoxy, alkyl, alkenyl, cycloalkyl, aryl, or benzyl.

10. A detergent composition according to claim 1, wherein the ligand is selected from:
1,1-bis(pyridin-2-yl)-N-methyl-N-(pyridin-2-ylmethyl)methylamine;
N,N-bis(pyridin-2-yl-methyl)-bis(pyridin-2-yl)methylamine, hereafter referred to as N4Py.
N,N-bis(pyridin-2-yl-methyl)-1,1-bis(pyridin-2-yl)-1-aminoethane, hereafter referred to as MeN4Py,
N,N-bis(pyridin-2-yl-methyl)-1,1-bis(pyridin-2-yl)-2-phenyl-1-aminoethane, hereafter referred to as BzN4Py 1,1-bis(pyridin-2-yl)-N,N-bis(6-methyl-pyridin-2-ylmethyl)methylamine;
1,1-bis(pyridin-2-yl)-N,N-bis(5-carboxymethyl-pyridin-2-ylmethyl)methylamine;
1,1-bis(pyridin-2-yl)-l-benzyl-N,N-bis(pyridin-2-ylmethyl)methylamine; and
1,1-bis(pyridin-2yl)-N,N-bis(benzimidazol-2-ylmethyl)methylamine, 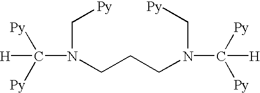
wherein —Py represents pyridin-2-yl, 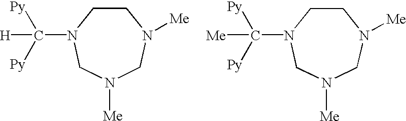
wherein —Py represents pyridin-2-yl.

11. A detergent composition according to claim 1, in which the ligand has the general formula: 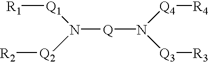
wherein:
Q₁, Q₂, Q₃, Q₄ are [CR5R6]ₙ with R5, and R6 each inpendently selected from from hydrogen, hydroxyl, halogen, —R and —OR, wherein R represents alkyl, alkenyl, cycloalkyl, heterocycloalkyl, aryl, heteroaryl or a carbonyl derivative group with n=1-4;
Q is [CR5R6]ₙ with R5, and R6 each inpendently selected from from hydrogen, hydroxyl, halogen, —R and —OR, wherein R represents alkyl, alkenyl, cycloalkyl, heterocycloalkyl, aryl, heteroaryl or a carbonyl derivative group with n=2, 3 or 4;
R₁, R₂, R₃, R₄ each independently represent an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole, or an transition metal complex thereof, preferably iron, manganese, copper or cobalt.

12. A detergent composition according to claim 11, wherein:
Q is defined such that a=b=0, c=2 or 3 and n=1; R₁, R₂, R₃, R₄ each independently represent a coordinating group selected from optionally substituted pyridin-2-yl, optionally substituted imidazol-2-yl, optionally substituted imidazol-4-yl, optionally substituted pyrazol -1-yl, and optionally substituted quinolin-2-yl.

13. A detergent composition according to claim 11, wherein:
R₁, R₂, R₃ each independently represent a coordinating group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole; and
R₄ represents a group selected from hydrogen, C₁₋₂₀ optionally substituted alkyl, C₁₋₂₀ optionally substituted arylalkyl, aryl, and C₁₋₂₀ optionally substituted NR₃⁺ (wherein R=C₁₋₈-alkyl).

14. A detergent composition according to claim 11, wherein:
Q is defined such that a=b=0, c=2 or 3 and n=1;
R₁, R₂, R₃ each independently represent a coordinating group selected from optionally substituted pyridin-2-yl, optionally substituted imidazol-2-yl, optionally substituted imidazol-4-yl, optionally substituted pyrazol-1-yl, and optionally substituted quinolin-2-yl; and
R₄ represents a group selected from hydrogen, C₁₋₁₀ optionally substituted alkyl, C₁₋₅-furanyl, C₁₋₅ optionally substituted benzylalkyl, benzyl, C₁₋₅ optionally substituted alkoxy, and C₁₋₂₀ optionally substituted N⁺Me₃.

15. A detergent composition according to claim 11, wherein:
R₁, R₄ each independently represent a coordinating group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole; and
R₂, R₃ each independently represent a group selected from hydrogen, C₁₋₂₀ optionally substituted alkyl, C₁₋₂₀ optionally substituted arylalkyl, aryl, and C₁₋₂₀ optionally substituted NR₃⁺ (wherein R=C₁₋₈-alkyl).

16. A detergent composition according to claim 11, wherein:
Q is defined such that a=b=0, c=2 or 3 and n=1;
R₁, R₄ each independently represent a coordinating group selected from optionally substituted pyridin-2-yl, optionally substituted imidazol-2-yl, optionally substituted imidazol-4-yl, optionally substituted pyrazol-1-yl, and optionally substituted quinolin-2-yl; and
R₂, R₃ each independently represent a group selected from hydrogen, C₁₋₁₀ optionally substituted alkyl, C₁₋₅-furanyl, C₁₋₅ optionally substituted benzylalkyl, benzyl, C₁₋₅ optionally substituted alkoxy, and C₁₋₂₀ optionally substituted N⁺Me₃.

17. A detergent composition according to claim 1, wherein the ligand has the general formula (III), or its protonated or deprotonated analogue: 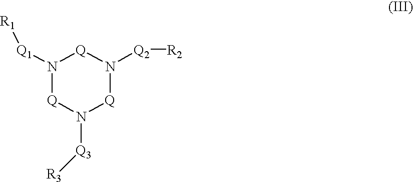
wherein:
R₁, and R₂, independently represent a group selected from an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole;
R₃ represent a group selected from hydrogen, hydroxyl, halogen, —NH—C(NH)NH₂, —R and —OR, wherein R=alkyl, alkenyl, cycloalkyl, heterocycloalkyl, aryl, heteroaryl or a carbonyl derivative group,
Q independently represent a group selected from C₂₋₃-alkylene optionally substituted by H, benzyl or C₁₋₈-alkyl;
Q₁, Q₂, Q₃, are [CR5R6]ₙ with R5, and R6 each inpendently selected from from hydrogen, hydroxyl, halogen, —R and —OR, wherein R represents alkyl, alkenyl, cycloalkyl, heterocycloalkyl, aryl, heteroaryl or a carbonyl derivative group with n=0, 1 or 2,
or an transition metal complex thereof, preferably iron, manganese, copper or cobalt.

18. A detergent composition according to claim 17, wherein two of R₁, R₂ each independently represent a coordinating group selected from optionally substituted pyridin-2-yl, optionally substituted imidazol-2-yl, optionally substituted imidazol-4-yl, optionally substituted pyrazol-1-yl, and optionally substituted quinolin-2-yl and R3 represents hydrogen, —CH₂—, —CH₂CH₂—, or benzyl; and Q₁ and Q₂ represent a group selected from —CH₂— and —CH₂CH₂—; and Q represents —CH₂CH_{2—.}

19. A detergent composition according to claim 17, wherein R1, R2, R3 each independently represent a coordinating group selected from optionally substituted pyridin-2-yl, optionally substituted imidazol-2-yl, optionally substituted imidazol-4-yl, optionally substituted pyrazol-1-yl, and optionally substituted quinolin-2-yl; and Q1=Q2=Q3=—CH2—

20. A detergent composition according to claim 17, wherein the ligand is selected from: 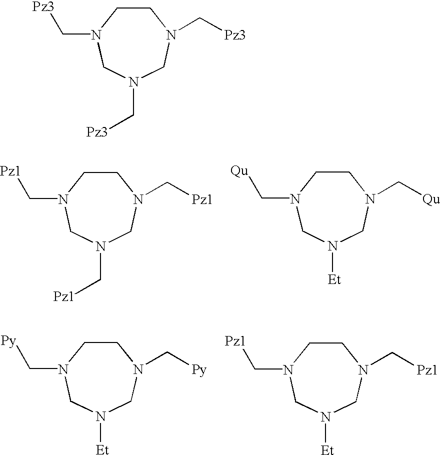
wherein —Et represents ethyl, —Py represents pyridin-2-yl, Pz3 represents pyrazol-3-yl, Pz1 represents pyrazol-1-yl, and Qu represents quinolin-2-yl.

21. A detergent composition according to claim 1, wherein the ligand has the general formula (IV), or its protonated or deprotonated analogue: 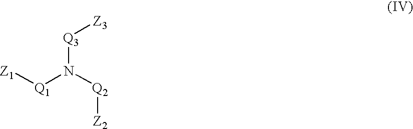
wherein:
Q₁, Q₂, Q₃, are [CR5R6]ₙ with R5, and R6 each inpendently selected from from hydrogen, hydroxyl, halogen, —R and —OR, wherein R represents alkyl, alkenyl, cycloalkyl, heterocycloalkyl, aryl, heteroaryl or a carbonyl derivative group with n=1 or 2;
Z₁, Z₂ and Z₃ independently represent a coordinating group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole,
or an transition metal complex thereof, preferably iron, manganese, copper or cobalt.

22. A detergent composition according to claim 21, wherein Z₁, Z₂ and Z₃ independently represent a coordinating group selected from optionally substituted pyridin-2-yl, optionally substituted imidazol-2-yl, optionally substituted imidazol-4-yl, optionally substituted pyrazol-1-yl, and optionally substituted quinolin-2-yl; and Q1, Q2, Q3 each represent a group selected from —CH₂— and —CH₂CH₂—.

23. A detergent composition according to claim 21, wherein Z₁, Z₂ and Z₃ each represent optionally substituted pyridin-2-yl and Q1, Q2, Q3 each represent a group selected from —CH₂— and —CH₂CH₂—.

24. A bleaching composition according to claim 21, wherein the ligand is selected from tris(pyridin-2-ylmethyl)amine, tris(3-methyl-pyridin-2-ylmethyl)amine, tris(5-methyl-pyridin-2-ylmethyl)amine, and tris(6-methyl-pyridin -2-ylmethyl)amine.

25. A detergent composition according to claim 1, wherein the ligand has the general formula: 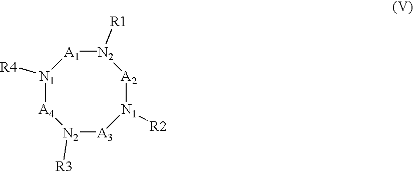
wherein:
R1-R4=H
A1, A2, A3 and A4 represents bridging groups according to the following definition:
A1=(C═O)—Y1—(C═O); A2=Y2; A3=(C═O)—Y3—(CR)2—; A4=(C═O)—Y4—C(R)2—
wherein Y1, Y3, and Y4 each represent a bridging group having, zero, one, two or three carbon containing nodes for substitution, and Y2 is a bridging group having at least one carbon containing node for substitution, each said node containing a C(R), or a C(R)2 unit and each R substituent being the same or different from the remaining R substituents and being selected from the group consisting of methyl, cycloalkyl, cycloalkenyl, alkenyl, aryl, alkynyl, alkylaryl, halogen, alkoxy, or phenoxy, CH2-CF3, CF3 and combinations thereof, or form a substituted or unsubstituted benzene ring of which two carbon atoms in the ring form nodes in he Y unit, or together with a paired R substituent bound to the same carbon atom form a cycloalkyl or cycloalkenyl ring, which may include an atom other than carbon,
or an transition metal complex thereof, preferably iron, manganese, copper or cobalt.

26. A detergent composition according to claim 25, wherein Y2 is a substituted or unsubstituted benzene ring having halogen, alkyl or alkoxy substituents thereon; and wherein Y3 and Y4 are each zero; and wherein Y1 is one carbon containing node C(R)2 and R is methyl or ethyl.

27. A detergent composition according to claim 25, wherein a unit dose provides an aqueous concentration of air bleaching catalyst in the range 0.1 to 10 μM and a concentration of lipase in the range 0.01-10 KLU/l.
